(19) United States
(12) Patent Application Publication
(10) Pub. No.: US 2007/0271326 A1
(43) Pub. Date: Nov. 22, 2007

(54) Technical Solution to Written Calculations Engineering of the Digital Engineering Method for Hybrid Numeral Carry System and Carry Line

(76) Inventors: Zhizhong Li, Zhejiang Province (CN); Juyuan Xu, Zhejiang Province (CN)

Correspondence Address: BACHMAN & LAPOINTE, P.C., 900 CHAPEL STREET, SUITE 1201, NEW HAVEN, CT, 06510, US

(21) Appl. No.: 11/664,397

(22) PCT Filed: Sep. 29, 2005
(86) PCT No.: PCT/CN05/01598

§ 371 Date: Jun. 7, 2007

(30) Foreign Application Priority Data
Sep. 30, 2004 (CN) 200410084836.0
Sep. 30, 2004 (CN) 200410084837.5

(51) Int. Cl. G06F 7/50

(52) U.S. Cl. 708/700

(57) ABSTRACT

The present invention relates to the digital engineering method and the field of written calculation engineering, and it puts forward a new digital engineering method which could remarkably increase the computation speed and greatly reduce the error rate of written calculation. The present invention uses the “method of hybrid numeral carry system and carry line”, in which K common Q-ary numerals that participate in the computation of addition and subtraction are transformed into K or 2K numerals of hybrid numeral carry system, then said K or 2K numerals are added for the sum in the hybrid numeral carry system. “Adding by place” is performed from the lowest place or at each place at the same time, and the number of the sum is written into the next computation layer; meanwhile, the obtained “hybrid numeral carry” is put into the next computation layer or at the empty place or zero place of the adjacent high place of any data line that has not undergone the computation in the present computation layer. Such computation is repeated until only one numeral is obtained after the computation in the computation layer. Then the finally obtained numeral is the sum of the addition in the hybrid numeral carry system. The present invention also provides the technical solution to the written calculation engineering of hybrid numeral carry system and carry line.

### TECHNICAL FIELD

The present invention relates to the digital engineering method and the field of written calculations engineering.

### BACKGROUND ART

Digital engineering includes numerically controlled machine tool, large-and medium-sized digitized equipment and digital systematic engineering, etc. The “digital engineering” of the present invention specially refers to “digital computation systematic engineering”. It does not solve any specific arithmetic question, theorem proving, geometrical question or concerns some mathematical thinking, but it relates to the technical solution of realizing the digital engineering of the computation system per se like four arithmetic operations principle. It is closely associated with the specific calculation tools. It is known that there are many kinds of “calculations”, except for “approximate calculation”, “analog calculation” and “calculation without tools” (mental calculation, finger calculation, oral calculation, etc., including the corresponding pithy formula, rapid calculation, and estimation), the rest of calculations are “numerical calculations that use tools”. In human history, numerical calculations that use tools include written calculation, count calculation and abacus calculation, mechanical calculation, and electrical calculation, etc. Nowadays, only digital electrical calculation, abacus calculation, and written calculation remain, so the corresponding digital calculation systematic engineering includes three kinds, which are digital computer, abacus, and “numerical calculation systematic engineering” that uses a pen and paper for written calculation, which is called “written calculation engineering” for short.

The four arithmetic operations are the basic computations of numerals. As Engels has said, “arithmetic (is the essential of all mathematics)”, and addition is the most basic computation in the four arithmetic operations. Therefore, we should certainly put particular attention on the four arithmetic operations, especially the addition. The four arithmetic operations in the current digital engineering method, first of all addition, are not quite satisfactory, the major deficiencies are that the speed of computation is slow and in subtraction, the negatives are not brought to their full play, meanwhile, successive subtraction cannot be done. Especially in the combined computations of addition and subtraction, the computations cannot be finished in a single step; in multiplication, the deficiencies of addition expand and become more serious; in division, the above-mentioned deficiencies exist, too. In summary, in the smallest mathematical entity—the rational number entity, the situation of the four arithmetic operations is not satisfactory.

In digital engineering of written calculation, dissection of the computation shows that some connotative computation procedures exist, thus causing some “hidden trouble”. Take addition of two numerals as an example, the formula thereof is as formula 1: 123456+345678=469134 [all the numerals in this text whose numerical system are not indicated are common decimal numerals, the same below], wherein the sum at the tens place is 3, and the micro-program operation is as follows in a dissection: \textcircled{a} carry from the units place; \textcircled{b} the two tens places 5 and 7 are added to the carry of the lower place, i.e., (5+7+1), and the units place of the sum is taken; \textcircled{C} the carry of the sum of (5+7+1) is sent to the higher place, and the rest of the places have the similar situation. Another example is as example 2, wherein three numerals are to be added for the sum, and the formula thereof is as formula 2: 78+297+295=634. It can be seen that the above-mentioned deficiencies are more serious. It is obvious that the following deficiencies exist:

a. It is difficult to mark the carry. If numerals of smaller size are used to indicate the carry, it is liable to cause confusion and the area of the numeral is limited. In particular, the situation is more annoying when 456789 is to be represented, because if the “.” is written between the numerals, it is liable to be mixed up with a decimal, and it is inconvenient to represent 456789; if fingers are used to count the numbers, it is slow and inconvenient; if mental calculation is performed, it is a hard mental work and mistakes usually occur.

b. Usually when two numerals are added, there will be three numerals at each place to be added for a sum, so there is the need for a three-layered computation, and when three or more numerals are to be added for a sum, it becomes more inconvenient.

c. It is difficult to check the computations. The computation is usually performed once again, so it is time-consuming and labor-consuming.

Subtraction is more troublesome than addition, and “successive subtraction” within the same vertical formula is impossible, so it must be separated; especially in the combined computations of addition and subtraction, the computation cannot be finished in a single step. In multiplication, this problem is more serious, besides, the formats for the computations of addition, subtraction, multiplication and division are not uniform, and a different format is used for division.

On the other hand, in computer digital engineering, there are also a lot of numerical value computations, and these numerals are usually represented by the common binary numerals, and the negatives are usually represented by the true form, the one's complement, the complement, and the frame shift, etc. In the current computers, computations are all carried out with two numerals, and “multiple computations” cannot be realized. The so-called “multiple computation” means that more than two numerals are added or subtracted at the same time. In the computers that adopt other common numerical systems like the common Q-ary, a lot of corresponding complexities exist [Q is a natural numeral]. Moreover, in digital engineering of abacus, there are also a great amount of numerical computations, and these numerals are usually “combined Q-ary” numerals using common binary and common quinary. Therefore, the pithy formulae for the computations are miscellaneous and there are the corresponding complexities.

### SUMMARY OF THE INVENTION

The present invention put forward a new digital engineering method which can remarkably increase the computation speed and can enhance the guarantee for the correctness of the computation. In written calculation engineering, the error rate of written calculation is greatly reduced.

The present invention also provides the technical solution of the “written calculation engineering” that uses said “hybrid numeral carry system and carry line method”. The computation speed is remarkably increased, meanwhile, the guarantee for the correctness of the computation is enhanced and the error rate of written calculation is greatly reduced.

According to one aspect of the present invention, a digital engineering method of hybrid numeral carry system and carry line is provided, which uses numerals of “hybrid numeral carry system” and carries out computations by the “digital engineering method of hybrid numeral carry system and carry line”. The computation with hybrid numeral carry system could be performed by one of the following solutions: solution 1 (suitable for computer and written calculation engineering): \textcircled{1} the common Q-ary numeral is encoded or otherwise transformed into hybrid carry system numeral; \textcircled{2} hybrid numeral carry system computation (“counterpart scratching”, “scratching Q”, “accumulating”); \textcircled{3} numeral of hybrid numeral carry system is decoded or otherwise transformed into common Q-ary numeral; solution 2 (suitable for computer, abacus, or for written calculation engineering, or it may be left un-used): \textcircled{1} common Q-ary numeral is encoded or otherwise transformed into numeral of hybrid numeral carry system; and the numeral of hybrid numeral carry system is encoded into “numeral of encoded all one carry system”; \textcircled{2} “encoded all one carry system” computation (“counterpart scratching”, “scratching Q”, “accumulating”); \textcircled{3} “numeral of encoded all one carry system” is decoded into numeral of hybrid numeral carry system; and the numeral of hybrid numeral carry system is decoded or otherwise transformed into common Q-ary numeral; solution 3 (suitable for computer): \textcircled{1} the common Q-ary numeral is encoded or otherwise transformed into numeral of hybrid numeral carry system; and the numeral of hybrid numeral carry system is encoded or otherwise transformed into {0, ±1} binary numeral (a special case thereof is common binary); \textcircled{2} {0, ±1} binary computation (“counterpart scratching”, “scratching Q”, “accumulating”); \textcircled{3} the {0, ±1} binary numeral is decoded or otherwise transformed into numeral of hybrid numeral carry system; and the numeral of hybrid numeral carry system is decoded or transformed into common Q-ary numeral; solution 4 (suitable for computer): \textcircled{1} the common Q-ary numeral is encoded or otherwise transformed into numeral of hybrid numeral carry system; and the numeral of hybrid numeral carry system is encoded or transformed into “encoded {0, ±1} binary numeral”; \textcircled{2} “encoded {0, ±1} binary” computation (“counterpart scratching”, “scratching Q”, “accumulating”); \textcircled{3} the “encoded {0, ±1} binary numeral” is decoded or otherwise transformed into numeral of hybrid numeral carry system; and the numeral of hybrid numeral carry system is decoded or otherwise transformed into common Q-ary numeral. In the present invention, solutions 1 and 2 are adopted.

In the first process,

step 1: suppose that K common Q-ary numerals participate in the computations of addition and subtraction, K is an integer and K≦2, and Q is a natural numeral; and these numerals are transformed into K or 2K numerals of hybrid carry system;

step 2: two of the K or 2K numerals are added for sum by using the hybrid numeral carry system; the computation starts from the lowest place, that is, at a certain place, said two numerals are added by place; then the sum of “adding by place” of said two numerals at said place is obtained by “counterpart scratching”, “scratching Q”, and “accumulating”; said sum is taken into the next computation layer as the “partial sum” numeral; meanwhile, the obtained “hybrid numeral carry” is stored in the next computation layer or at the empty place or zero place of the adjacent higher place of any data line that has not undergone the computation in the present computation layer;

step 3: at the higher place adjacent to said certain place, the computation of step 2 is repeated; this processing is repeated until the highest places of said two numerals have been computed; when parallel computation is adopted, computations in steps 2 and 3 are performed on each place of the two numerals at the same time, then the present step can be skipped;

step 4: another two numerals of the K or 2K numerals are taken to perform the computations in steps 2 and 3; this processing is repeated until all the numerals in the K or 2K numerals or in the computation layer have been taken; when there is only one numeral left, it is directly moved to the next computation layer as the “partial sum” numeral;

step 5: in the next computation layer, the computations for sum as described in the previous steps 2, 3 and 4 are performed on said “sum by place” numeral and the “carry” numeral; this processing is repeated until only one numeral is obtained after the computation in the computation layer; then the number of the sum finally obtained by addition computation with hybrid numeral carry system is just the result of addition and subtraction computations on the K common Q-ary numerals.

Or in the second process:

step 1: suppose that K common Q-ary numerals participate in the computation of addition and subtraction, K is an integer and K≧2, and Q is a natural numeral; and these numerals are transformed into K or 2K hybrid carry method numerals;

step 2: starting from the lowest place, that is, two to K or 2K numerals are taken to be added at the same time at a certain place; “counterpart scratching”, “scratching Q” and “accumulating” are adopted; that is, when two numerals are taken, the sum of “adding by place” of said two numerals at said place is obtained and is taken into the next computation layer as the “partial sum” numeral; meanwhile, the obtained “hybrid numeral carry” is stored in the next computation layer or at the empty place or zero place of the adjacent higher place of any data line that has not undergone the computation in the present computation layer;

step 3: another two numerals are taken from the K or 2K numerals to perform the computation of step 2; this processing is repeated until the K or 2K numerals or all the numerals in computation layer have been taken; when there is only one numeral left, it is directly moved to the next computation layer as the “partial sum” numeral;

when each of the numerals at the same place are computed at the same time, the computations of steps 2 and 3 are performed at the same time, then the present step can be skipped; at this time, “counterpart scratching” is first performed on the n numerals whose sum is 0 at the same place; then “scratching Q” is performed on n numerals whose sum is mQ; n is an integer and n≧2, m is an integer; the obtained “hybrid numeral carry” is stored in the next computation layer or at the empty place or zero place of the adjacent higher place of any data line that has not undergone the computation in the present computation layer; at the same place, the rest numerals are “accumulated” or are directly moved to the next computation layer; the accumulation is “multiple (not less than 2) numerals accumulation”, when the common “accumulation” of two numerals is adopted, sequential serial accumulation is performed;

step 4: at the higher place adjacent to said certain place, the computations in steps 2 and 3 are repeated, and this processing is repeated until computation has been performed on the highest place of the K or 2K numerals;

step 5: in the next computation layer, the computation for sum as described in the above steps 2, 3 and 4 is performed on said “sum by place” numeral and the “carry” numeral; this processing is repeated until only one numeral is obtained by the computation in the computation layer; then the number of the sum finally obtained by addition computation with hybrid numeral carry system is just the result of addition and subtraction computations on the K common Q-ary numerals

Or in the third process:

step 1: suppose that K common Q-ary numerals participate in the computation of addition and subtraction, K is an integer and K≧2, and Q is a natural numeral; and these numerals are transformed into K or 2K numerals of hybrid carry system;

step 2: the so-called “two-dimensional computation” is adopted, i.e., computation is performed at each place of the K or 2K numerals at the same time, meanwhile, “counterpart scratching” is performed on the n numerals whose sum is 0 at each place; n is an integer and n≧2;

step 3: the so-called “two-dimensional computation” is adopted, i.e., computation is performed at each place of the K or 2K numerals at the same time, meanwhile, “scratching Q” is performed on n numerals whose sum is mQ at each place; n is an integer and n≧2, m is an integer; the obtained “hybrid numeral carry” is stored at the empty place or zero place of the adjacent higher place of any data line in the next computation layer;

step 4: the so-called “two-dimensional computation” is adopted, i.e., computation is performed at each place of the K or 2K numerals at the same time, meanwhile, the rest of the numerals at each place are “accumulated”; or they are directly moved to the next computation layer; the accumulation is “multiple (not less than 2) numerals accumulation”; when common “accumulation” of two numerals is adopted, sequential serial accumulation is performed;

step 5: in the next computation layer, the computations for sum as described in the above steps 2, 3 and 4 are performed on said “sum by place” numeral and the “carry” numeral ; this processing is repeated until only one numeral is obtained by the computation in the computation layer; then the number of the sum finally obtained by addition computation with hybrid numeral carry system is just the result of addition and subtraction computations on the K common Q-ary numerals.

In the digital engineering method of hybrid numeral carry system and carry line, the computation thereof uses the “carry line method”, that is, during computation, the generated carry is stored in the “carry line” of the adjacent higher place to be treated as a general computation number, then it is computed together with the “sum by place”.

When the computation for sum is performed for n numerals in K numerals, if, at a certain place, the “sum of adding by place” of n computation numbers is zero, but a carry m (which has the same sign as the sum of the n numerals) is produced; n is an integer and n≧2, m is an integer, the carry is put into the next computation layer or at the empty place or zero place of the adjacent higher place of any data line that has not undergone the computation in the present computation layer; then a certain place of the n computation numbers are set to be “0” in a logical manner so that they will not participate in the subsequent computations, this is called “scratching Q”; in “scratching Q”, when m=0, it is called “counterpart scratching”; or “counterpart scratching” and “scratching Q” may not be adopted.

The numeral of hybrid numeral carry system may not be encoded, or it may be encoded by the numeral of hybrid numeral carry system, or it may be also encoded by all one code, that is, each place of numeral S of the respective numerals of the hybrid numeral carry system is corresponded by 1 with the number of |S| arranged from the lowest place to the higher places, and the rest of the higher places are 0; meanwhile, the sign of S, i.e., the sign that indicates if the numeral of said place is positive or negative, is used as the sign of each place in the corresponding all one code. When all one code is used to encode numerals of hybrid numeral carry system, the addition of n numerals is only the non-repetitive arrangement of 1 or 1̅ of the n numerals, which is called “arrangement of 1”; and the encoding and decoding of the all one code could use either fixed code length or variable code length.

According to another aspect of the present invention, a technical solution of the “written calculation engineer” with hybrid numeral carry system and carry line is provided. The computation of hybrid numeral carry system can be performed by the previously described solution 1 or solution 2. The technical solution of the “written calculation engineering” of the present invention is illustrated by solution 1. The digital engineering method in written calculation engineering can adopt the previously described first or second process. The second process is used herein. During computation, the common Q-ary numerals are first transformed into the general form of the numerals of hybrid numeral carry system, then they are put into computation for sum by the “hybrid carry method HJF” using hybrid numeral carry system and carry line. The result of computation is a “numeral of hybrid numeral” of the “hybrid numeral carry system”. Finally, the “numeral of hybrid numeral” is transformed into common Q-ary numeral or common decimal numeral, if necessary.

The new technical solution of written calculation engineering adopts the hybrid decimal, enhanced decimal, or partial decimal among the hybrid Q-ary, enhanced Q-ary or partial Q-ary for computations.

The new technical solution of written calculation engineering adopts “multiple computations”, that is, the addition and subtraction of a plurality of numerals are done at one computation, thus completely overcoming the difficulty in “successive subtraction” and “successive addition and subtraction”. Meanwhile, multiplication is in substance a “successive addition”, and division is in substance a “successive subtraction”, so the “multiple computations” can also be used in multiplication and division.

In the “written calculation engineering” of hybrid numeral carry system and carry line, the computation numerals are numerals of hybrid numeral carry system, and Q is a natural number. They may not be encoded, or they may be encoded by the numeral of hybrid numeral carry system, or they may be encoded by all one code, that is, each place of numeral S of the respective numerals of the hybrid numeral carry system is corresponded by 1 with the number of |S| arranged from the lowest place to the higher places, and the rest of the higher places are 0; meanwhile, the sign of S, i.e., the sign that indicates if the numeral of said place is positive or negative, is used as the sign of each place in the corresponding all one code. When all one code is used to encode numerals of hybrid numeral carry system, the addition of n numerals is only the non-repetitive arrangement of 1 or 1̅ of the n numerals, which is called “arrangement of 1”; and the encoding and decoding of the all one code could use either fixed code length or variable code length. In the written calculation engineering of hybrid numeral carry system and carry line according to the present invention, the variable code length is used.

The technical solution of “written calculation engineering” adopts the digital engineering method of hybrid numeral carry system and carry line. When the computation for sum is performed for n numerals in K numerals, if, at a certain place, the sum of adding by place of n computation numbers is zero, but a carry m (which has the same sign as the sum of the n numerals) is produced; n is an integer and n≧2, m is an integer, the carry is put into the next computation layer or at the empty place or zero place of the adjacent higher place of any data line that has not undergone the computation in the present computation layer; then a certain place of the n computation numbers are set to be “0” in a logical manner SO that they will not participate in the subsequent computations, this is called “scratching Q”; in “scratching Q”, when m=0, it is called “counterpart scratching”; or “counterpart scratching” and “scratching Q” may not be adopted. In the new technical solution of written calculation engineering, computations of “counterpart scratching (reduction of hybrid numerals)” and “scratching Q” are widely used for increasing the computation speed and simplifying the computation picture.

### PREFERRED EMBODIMENTS

Part I Digital engineering method of hybrid numeral carry system and carry line

1. <<Method of Carry Line>>

1.1 Carry and <<Method of Carry Line>>

In numeral value computations in digital engineering like computers, one of the keys for increasing the computation speed is “carry and borrow”, which is called “carry” for short. The acquiring and storing of the carry and the participation of the carry in the computation are crucial. “Carry” is competing for “speed”. In written calculations, it directly affects the “error rate”. This part takes the written calculation engineering as an example to illustrate it.

The so-called <<Method of carry line>> is the method that during the computation process, the generated carry is stored in the position that equals to the position of the “sum by place” numeral and that participates in the computation, then it participates in the computation together with the “sum by place”. Generally, when two numerals of the same computation layer are added, the carries in different places are arranged in a line which is called the “carry line”. (The concept of “computation layer” will be explained in the next section). An example is as follows: suppose that two common decimal numerals are added for sum, and the formula for sum is as formula 3: 123456+345678=469134. The units place computation is (6+8)=14, and the carry 1 thereof is written into the higher place of the next line, and so on. When two numerals are added in the formula, the summing at each place without taking into account the carry is called “adding by place ⊕”, and the sum thereof is called “sum by place”, and the data line of sum by place is called “⊕ line”. The ⊕ line and the carry line form the “computation layer”.

1.2 Analysis of the <<Method of Carry Line>>

1.2.1 Analysis of Adding Two Numerals for the Sum

It can be seen from the above section that in the addition computation by means of the <<Method of carry line>>, \textcircled{1} when two numerals are added, there are only two numerals to be added at each place, and there is no difficulty to directly mark the carry in the carry line; \textcircled{2} it is very convenient to check the computation.

[Lemma 1] when two numerals are added, there is either a carry marked as 1 or no carry marked as 0 at any place;

[Lemma 2] when two numerals are added, the ⊕ sum at any place could be one of 0˜9, but when there is a carry to the higher place at said place, the ⊕ sum at said place can only be one of 0|8, and it cannot be 9.

It can be derived from [Lemma 1] and [Lemma 2] that [Theorem 1] when two numerals are added, the ⊕ sum at a certain place can be 9 if and only if said place does not have carry to a higher place.

1.2.2 The Concept of Layer and Computation Layer

Suppose that two numerals are to be added for the sum, and the formula is as formula 4: 5843029+4746979=10590008. It can be seen from formula 4 that the computations are carried out in different layers, and the computation layer decomposes an computation into sub-computations. In each computation layer, the sub-computation is decomposed into micro-computations. The micro-computation only performs one simple computation, and this is the concept of “layer” of computation. The concept of “layer” is a basic concept in mathematics. The <<Method of carry line>> is just based on said concept. The addition computation methods before also implies the concept of “layer” in substance, so the “layer” in the <<Method of carry line>> does not increase the complexity of the computation in general. On the contrary, the methods before imply the “layer”, so the complexity of computations is increased, which further causes the speed of computations to be slowed down.

1.2.3 The Unique Layer of Computation

When two numerals are added, multiple layers of computation may occur in some special cases, and there are the following relations among the layers.

[Lemma 3] when two numerals are added, if the computation layer prior to some place has a carry, no carry will occur in the following computation layers (deduced from lemma 1 and lemma 2).

[Lemma 4] when two numerals are added, if the computation layer after some place has a carry, it is certain that no carry exists in the previous computation layers (deduced from lemma 1 and lemma 2).

[Theorem 2] when two numerals are added, either none of the computation layers of the same place has carry, or all the computation layers of the same place has only one carry (deduced from lemma 1 and lemma 2).

[Deduction] when two numerals are added, the carry lines of all the layers could be combined into one carry line, and all the computation layers could be combined into one computation layer, except for the 0 computation layer (initial computation formula).

1.2.4 Analysis of Adding Three Numerals or More for the Sum

Suppose that three numerals are added for the sum, and the formula is 231+786+989=2006 (formula 5). Further, suppose that six numerals are added for sum, and the formula is 786+666+575+321+699+999=4046 (formula 6). Keys of operation are as follows:

\textcircled{1} The application of “scratching Q”. The so-called “scratching Q” is that when n numerals of Q-ary are added at a certain place, the sum of adding by place is zero, but a carry m is generated at said place (which is of the same sign as the sum of said n numerals), n is an integer and n≧2, m is an integer. The carry is put to the next computation layer or to the empty place or zero place of the adjacent higher place of any data line that has not undergone the computation in the present computation layer; meanwhile, said n numerals will no longer participate in the computation at a certain place. That is, when the sum of n numerals at the same place is mQ, the n numerals could all be scratched out, then m is supplemented to the empty place or 0 place of the adjacent higher place. In decimal, Q=10, and scratching Q is just “scratching ten”.

\textcircled{2} When a plurality of numerals are added, two or more computation layers will occur. In order to reduce the number of computation layers, in the empty place or 0 place of the same computation layer at the same place, the carry and ⊕ sum numeral could take any place; thus said “carry line” can be considered as that the carry from a certain place in an computation layer can be put to the next computation layer or to the empty place or zero place of the adjacent higher place of any data line that has not undergone the computation in the present computation layer.

\textcircled{3} The number of computation layers is reduced as much as possible. a. Smaller numerals are directly combined to be computed; b. carry is performed in “matched pairs” as much as possible; c. the number of numerals to be added in the first computation layer is reduced as much as possible, and the second or higher computation layer is made not to appear as far as possible.

\textcircled{4} At the same place, the numerals are “accumulated” or are directly moved to the next computation layer; the accumulation is “multiple (not less than 2) numerals accumulation”, when common “accumulation” of two numerals is adopted, sequential serial accumulation is performed; as for the “identical numerals” and “consecutive numerals”, the “partial sum” can be directly obtained.

2. Hybrid Numeral and Hybrid Numeral Carry System

2.1 <<Theory of Numerical System SZLL>>

2.1.1 The system of recording numerals according to the same rule so as to facilitate computations in a numerical system is called “the system of numeral representation system”, and “numerical system” for short. The <<Theory of numerical system SZLL>> is a science that studies the generation, classification, analysis, comparison, transformation and computation of numerical system. It is also a science that studies the application of numerical system to such branches of mathematics as number theory, group theory, set theory, game theory, etc., and to the neighboring subjects like multiple value logic, Walsh function, <<Model Random Theory MSL of narrow and broad senses>>, etc., especially to the computer, written calculation engineering and abacus in digital engineering field. It is one of the fundamental theories of mathematics. The Science of mathematics is the science of numerals. The basis of “numerals” is “numerical system”. Therefore, the <<Theory of numerical system SZLL>> is the basis for “number theory”, and it is one of the “cores” of “core mathematics”.

2.1.2 Place Value Numerical System

Suppose that a numeral system is to be constructed, wherein the numerals are represented by “numeral symbols” at different positions. “Numerical symbols” are also called “numerals”. All the numerals at each numeral place are assigned with a unit value (also called “place value”). The numerals are usually arranged horizontally from right to left, the values thereof are arranged from low (small) to high (large). The numerical system that represents each numeral in the whole numeral system in this way is called “place value numerical system”. The numerical systems we discussed below are all “place value numerical system”. They are also called “numerical system” where misunderstanding will not be caused.

2.1.3 Numerical System Has Three Factors: Numerical Place I, Numerical Element Set Zᵢ and Weight Lᵢ.

a. numerical place I refers to the position of the numeral of each place in the numerical system. I is an ordinal. When it is an integer, I in each place is represented from right to left, i.e., I=1, 2, 3, . . . indicating the first, second, third . . . place of said numeral.

b. numerical element set Zᵢ refers to the set formed by the “numeral elements” at the i-th place. In the same numerical system, the collectivity of the numerals of different signs at the same place forms the numerical symbol set, and elements within said numerical symbol set are called “elements of numerals”, and “numerical elements” for short. Hence, said numeral symbol set is called “numerical element set Z”. The numerical element set Zᵢ varies or remains the same according to the different values of i. When the Zᵢ at every place is the same Z, the corresponding numerical system is called “numerical system of single set” or “single numerical system”; when the Zᵢ of every place are not all same, the corresponding numerical system is called “numerical system of combined set” or “combined numerical system”.

The numerical elements in the numerical element set Zᵢ could be complex number or other various symbols. In the <<Theory of numerical system>>, numerical elements are represented by aⱼ (a₁, a₂, a₃, . . . ), j is a natural number and iaⱼ represents the numerical element aⱼ at the i-th place. It is assumed that when aⱼ=−A (A is complex number), there is the expression that aⱼ=A. The numerical element set Zᵢ is represented by the set {a₁, . . . ,aⱼ, . . . }, i.e., Z₁i={a₁, . . . ,aⱼ, . . . }; or literal wordings are used to indicate the characteristics of Zᵢ. For facilitating calculation, the numerical element aⱼ is chosen to be an integer represented by Arabic numerals.

The radix Pᵢ (Pᵢ is a natural number) of the numerical element set Zᵢ indicates the total number of the elements in the set. Engels has said that it “decides not only its own nature, but also the nature of all other numerals”. The different values of Pᵢ indicate the variation of the numerical element set Z_{i.} If the Pᵢ of all the places are the same P, it is called “single radix”; otherwise, it is called “mixed radix”.

In the “place value numerical system” of the <<theory of numerical system>>, the “empty place” in the numeral is defined to represent “null”, and the place value thereof is 0, so it is called “empty place 0”. “Empty place 0” is one kind of 0 and is one expressing form of 0, so it is a connotative 0 and is usually not indicated. In the numerical element set, “empty place” is a special numerical element, which is called “empty place element” and “empty element” for short. “Empty element” is the numerical element that each “place value numerical system” has, and it's indicated by “empty place” in the numerical element set. It is usually not indicated. “Empty element” is the only numerical element in the numerical element set that is usually not counted in the numerical element aⱼ and whose number is not counted, i.e., the number thereof is 0. On the other hand, in some special cases, in order to maintain uniform expressions, it is counted into the numerical element and the number thereof is 1.

c. Weight Lᵢ indicates the place value of the i-th place, and said place value is called “weight Lᵢ’. Lᵢ is a real number, but for the convenience of calculation, Lᵢ is usually chosen to be an integer, especially a natural number and is expressed by Arabic numeral. Different Lᵢ determine different place values. In the “theory of encoding”, the main characteristic of “encoding” lies in weight Lᵢ.

The common weight Lᵢ in practice uses the so-called “power weight”, i.e., make Lᵢ=Qᵢ⁽ⁱ⁻¹), Qᵢ is a real number. For easy calculation, Qᵢ is generally chosen to be a natural number and could be expressed by Arabic numeral or by the ordinary Chinese numeral. The common Lᵢ of each place is a power weight, and is the geometric proportion Q numerical system. Q is called the “basic number” of numerical system power weight or the “basic number” of the numerical system. Different basic numbers Q determine that the Lᵢ are different, and thereby determining different place values. Qᵢ varies with the change of the values of i, or it may remain the same. When the numerical system power weights Qᵢ of all the places have the same basic number Q, the corresponding numerical system is called “single Q-ary”, which is simplified as “Q-ary” or “carry system”. When the numerical system power weights Qᵢ of all the places do not all have the same basic number, the corresponding numerical system is called “combined Q-ary”. Another commonly used weight Lᵢ is “equal weight”, that is, the weights L of all the places are the same.

In any Q-ary numerical system having numerical element set of integer segment, when P=Q, the natural numbers can be expressed in a successive and unique form in said numerical system, which is called “successive numerical system” or “common numerical system”. With respect to the Q-ary, it is called “common Q-ary”.

When P>Q, natural numbers can be expressed successively in said numerical system, but sometimes they can also be expressed in various forms, and this is called “repetitive numerical system or “enhanced numerical system”. With respect to the Q-ary, it is called “enhanced Q-ary”.

When P<Q, natural numbers can only be expressed in a non-successive form, so it is called “intermittent numerical system” or “attenuating numerical system”. With respect to the Q-ary, it is called “attenuating Q-ary”.

On the basis of the three factors of numerical system as mentioned above, numerical system could have inexhaustible kinds.

2.2 Hybrid Numerals and Hybrid Numeral Carry System

When the numerical element set Zᵢ includes numerical element 0, said corresponding numerical system is called “0 inclusive numerical system”. As for the carry system, it is called “0 inclusive carry system”; when the numerical element set Zᵢ does not include numerical element 0, said corresponding numerical system is called “0 exclusive numerical system”. As for the carry method, it is called “0 exclusive carry system”.

When the numerical element set Zᵢ includes positive numerical elements, negative numerical elements or 0, the corresponding numerical system is called “numerical system of hybrid numeral”. (Numerical element 0 is a neutral numerical element.) With respect to the carry system, it is called “hybrid numeral carry system”; and the numerals in the numerical system of hybrid numeral is called “hybrid numerals”. Numerals having both positive numerical elements and negative numerical elements in the hybrid numerals are called “pure hybrid numerals”. “In the <<Theory of numerical system>>, when the positive and negative numerical elements in the numerical element set Zᵢ are opposite numerals to each other, the corresponding numerical system is called “symmetrical numerical system”. With respect to the Q-ary, it is called “symmetrical Q-ary”. When the positive and negative numerical elements in the numerical element set are not opposite numerals, the corresponding numerical system is called “asymmetrical numerical system”. With respect to the Q-ary, it is called “asymmetrical Q-ary”; when the positive and negative numerical elements in the numerical element set are not all opposite numerals, the corresponding numerical system is called “partial symmetrical numerical system”. With respect to the Q-ary, it is called “partial Q-ary”.

When all the numerical elements in the numerical element set Zᵢ are successive integers which form an “integer segment”, the corresponding numerical system is called “numerical system of integer segment”. As for the carry system, it is called “carry system of integer segment”. Engels has said that “0 has richer contents than any other numerals”. Since “0” has such special significance, in the <<Theory of numerical system>>, when the 0 inclusive integer segment has 0 removed therefrom, it is still a kind of special integer segment.

A “system of algebraic numerical system” is established in the <<Theory of numerical system>>. The name of a numerical system is “Zᵢ, Lᵢ”. As for a Q-ary, it is ZᵢQᵢ; as for a single numerical system, it is ZLᵢ; as for a combined Q-ary in the single numerical system, it is ZQᵢ; as for a Q-ary in the single numerical system, it is ZQ. The specific number of Q is represented by ordinary Chinese numerals.

With respect to the 0 inclusive common Q-ary, Z={0, 1, . . . , (Q−1)}, so ZQ={0, 1, . . . , (Q−1)}Q, Q is an integer and Q>1, and it is called “0 inclusive common Q-ary”, which can be represented by the symbol {0 inclusive, Q}. As for the 0 exclusive {1, 2, . . . , Q}Q, Q is a natural number, it is called “0 exclusive common Q-ary}, which can be represented by the symbol {0 exclusive, Q}. The 0 inclusive and 0 exclusive common Q-ary go by the general name of “common Q-ary”, where Q is a natural number, and it can be represented by the symbol {Q}. Where no misunderstanding would be caused, the “0 inclusive common Q-ary” can also be called “common Q-ary”, which is also represented by symbol {Q}. Hence, symbols {two} and {ten} can be used to represent common binary and common decimal.

The hybrid numeral carry system of this document is mainly classified into the following categories:

“Hybrid Q-ary” is a very important “symmetrical numerical system”. As for the 0 inclusive {0, ±1, . . . ±(Q−1)}Q-ary, where Q is an integer and Q>1, it is called “0 inclusive hybrid Q-ary”, and the symbol thereof is {0 inclusive, Q*}; as for the 0 exclusive {±1, ±2, . . . ±Q} Q-ary, where Q is a natural number, it is called “0 exclusive hybrid Q-ary”, and the symbol thereof is {0 exclusive, Q*}. The 0 inclusive and 0 exclusive hybrid Q-ary are called “hybrid Q-ary” in general, where Q is a natural number, and the symbol thereof is {Q*}. Where no misunderstanding will be caused, the “0 inclusive hybrid Q-ary” can also be called as “hybrid Q-ary” and represented by the symbol {Q*}. In the <<theory of numerical system>>, the name of {ten*} is “single radix number P=19, 0 inclusive, integral segment, symmetrical decimal”, which could be written as {nineteen, 0 inclusive, integer segment, symmetric} decimal, or as {0, ±1, ±2, . . . ±9} decimal. Usually, it is further represented by {ten*} which is called “hybrid decimal”. The name of {two*} is “single radix number P=3, 0 inclusive, integral segment, symmetrical decimal”, which could be written as {three, 0 inclusive, integer segment, symmetric} binary, or as {0, ±1} binary. Usually, it is further represented by {two*} which is called “hybrid binary”.

In enhanced Q-ary, a very important one is P=Q+1>Q (the “enhanced Q-ary specially refers to this kind in this text unless otherwise indicated, the same below). As for the 0 inclusive {0, ±1, . . . ±Q/2}Q-ary, where Q is a positive even number, it is called “0 inclusive enhanced Q-ary” and represented by the symbol {0 inclusive, Q^{Δ}}; as for the 0 exclusive {±1, ±2, . . . +(Q+1)/2} Q-ary, where Q is a positive odd number, it is called “0 exclusive enhanced Q-ary”, and the symbol thereof is {0 exclusive, Q^{Δ}}. The 0 inclusive and 0 exclusive enhanced Q-ary are called “enhanced Q-ary” in general, where Q is a natural number, and the symbol thereof is {Q^{Δ}}. Where no misunderstanding will be caused, the “0 inclusive enhanced Q-ary” can also be called as “enhanced Q-ary” and represented by the symbol {Q^{Δ}}. In the <<theory of numerical system>>, the name of {ten^{Δ}} is “single radix number P=11, 0 inclusive, integral segment, symmetrical decimal”, which could be written as {eleven, 0 inclusive, integer segment, symmetric} decimal, or as {0, ±1, ±2, . . . ±5} decimal. Usually, it is further represented by symbol {ten^{Δ}} which is called “enhanced decimal”. The name of {two^{Δ}} is “single radix number P=3, 0 inclusive, integral segment, symmetrical decimal”, which could be written as {three, 0 inclusive, integer segment, symmetric} binary, or as {0, ±1} binary. Usually, it is further represented by symbol {two^{Δ}}, which is called “enhanced binary”.

In partial Q-ary, an important case is that the “numerical element set” has only a largest positive numerical element but it does not have the corresponding negative numerical element, and the rest thereof are one kind of 0 or symmetrical numerical elements. Wherein a most important one is that the partial Q-ary is also a common Q-ary. In this document, the partial Q-ary refers only to this case. As for the 0 inclusive {0, ±1, . . . ±Q/(2−1), ±Q/2}Q-ary, where Q is a positive even number, it is called “0 inclusive partial Q-ary” and represented by the symbol {0 inclusive, Q′}; as for the 0 exclusive {±1, ±2, . . . , ±(Q−1)/2, (Q+1)/2} Q-ary, where Q is a positive odd number, it is called “0 exclusive partial Q-ary”, and the symbol thereof is {0 exclusive, Q′}. The 0 inclusive and 0 exclusive partial Q-ary are called “partial Q-ary” in general, where Q is a natural number, and the symbol thereof is {Q′}. Where no misunderstanding will be caused, the “0 inclusive partial Q-ary” can also be called as “partial Q-ary” and represented by the symbol {Q′}. Thus symbols {ten′} and {two′} can be used to represent “partial decimal” and “partial binary”. In the <<theory of numerical system>>, the name of {ten′} is “single radix number P=10, 0 inclusive, integral segment, partial symmetrical decimal”, which could be written as {ten, 0 inclusive, integer segment, partial symmetric} decimal, or as {0, ±1, ±2, . . . ±4, 5} decimal. Usually, it is further represented by symbol {ten′} which is called “partial decimal”. The name of {two′} is “single radix number P=2, 0 inclusive, integral segment, symmetrical decimal”, which could be written as {two, 0 inclusive, integer segment, partial symmetric} binary, or as {0, 1} binary. Usually, it is further represented by symbol {two′}, which is called “partial binary”.

2.3 Encoding of Hybrid Numerals

The method of encoding with hybrid numerals is called “hybrid numeral encoding”.

When A-ary numerical elements are encoded by B-ary numerals, etc., the A-ary numerals are arranged into the corresponding B-ary numerals, etc. by place, which is called “A-ary numeral encoded by B-ary numerals” or “B-encoded A numeral”, or “encoded B numeral” or “encoded numeral” for short. For example, {ten} 328={two} 101001000; wherein “encoded {two} numeral” is 0011, 0010, 1000. As mentioned in the above, “encoded {0, ±1} binary numeral” is the “encoded numeral” encoded by {0, ±1} binary (the special case thereof is common binary). The computation of “encoded B numeral” is the computation of “encoded B-ary”. At this time, A-ary computation is performed between the places of the A-ary numeral, but B-ary computation is performed in each place. When the A-ary numerical element is encoded by B-ary numeral, etc., the maximum places of the required B-ary numerical is called “code length”. The fixed “code length” is called “fixed code length”. If the highest place 0 is not indicated so as to make it an “empty place 0”, the corresponding “code length” is variable, which is called “variable code length”.

In the digital engineering method of hybrid numeral carry system and carry line, the numeral of hybrid numeral carry system may not be encoded or may be encoded by general numerals of hybrid numeral carry system; it can also be encoded by all one code, that is, each place of numeral S of the numerals of the hybrid numeral carry system is corresponded by 1 with the number of |S| arranged from the lowest place to the higher places sequentially, and the rest of the higher places are all 0. Meanwhile, the numeral sign of S, i.e., the sign that indicates if the numeral of said place is positive or negative, is used as the numeral sign of each place in the corresponding all one code. When all one code is used to encode numerals of hybrid numeral carry system, the addition of n numerals is only the non-repetitive arrangement of 1 or 1̅ of the n numerals, which is called “arrangement of 1”; and the encoding and decoding of the all one code could use either fixed code length or variable code length.

3. <<Hybrid Carry Method HJF>> and Four Arithmetic Operations of the Hybrid Decimal {ten*} Thereof.

The method that uses hybrid numeral carry system and <<method of carry line>> to perform the computations of rational numbers is called <<digital engineering method of hybrid numeral carry system and carry line>>, or <<hybrid carry method HJF>> for short. The computations of hybrid numeral carry system can use one of the previously mentioned four solutions. In the present invention, the <<hybrid carry method HJF>> adopts solution 1 which is depicted by written calculation engineering; and the previously mentioned process one or process two can be adopted. Here, process two is adopted. Typical examples of hybrid numeral carry system are hybrid Q-ary, enhanced Q-ary, and partial Q-ary.

Wherein, the method of carrying out computations of rational numbers by using the hybrid Q-ary and <<carry line method>> is named as <<digital engineering method of hybrid Q-ary and carry line>>, or as <<hybrid carry method HJF>> where misunderstanding would not be caused. Suppose that K common Q-ary numerals participate in the computation of addition and subtraction, K is an integer not less than 2 and Q is a natural number. The positive and negative signs of these common Q-ary numerals are assigned to each place of the corresponding numeral, thus the hybrid Q-ary numerals are formed. When Q=10, the hybrid Q-ary becomes a hybrid decimal {ten*}.

Wherein, the method of carrying out computations of rational numbers by using the enhanced Q-ary and <<carry line method>> is named as <<digital engineering method of enhanced Q-ary and carry line>>, or as <<enhanced carry method ZJF>> for short. Suppose that K common Q-ary numerals participate in the computation of addition and subtraction, K is an integer not less than 2 and Q is a natural number. All these numerals are transformed into K or 2K enhanced Q-ary numerals.

(I) Take the transformation of 0 inclusive {Q} to {Q^{Δ}} as an example:
{Q}={0,1, . . . ,(Q−1)}Q, Q is an integer and Q>1 \textcircled{1}
{Q^{Δ}}={0,±1, . . . ,±Q/2}Q. Q is a positive even number \textcircled{2}

It can be learnt from \textcircled{1} and \textcircled{2} that Q is an even number and Q≧2
∵Q≧2, 2Q≧2+Q, Q≧Q/2+1, ∴(Q−1)≧Q/2

When Q=2,(Q−1)=Q/2; i.e. as far as the absolute value is concerned, the {two} numeral represented by the largest numerical element in {two} equals to the {two} numeral represented by the largest numerical element in {two^{Δ}}; when Q is an even number that is greater than 2, (Q−1)>Q/2; i.e. as far as the absolute value is concerned, the {Q} numeral represented by the largest numerical element in {Q} is always larger than the {Q} numeral represented by the largest numerical element in {Q^{Δ}}. At this time, the {Q} numerical element of (Q−1)={Q^{Δ}} 1 1̅, that is, if the {Q} numerical element (Q−1) is transformed into the corresponding {Q^{Δ}} numeral, it is a number of two places 1 1̅. Wherein the high place is in fact a “carry”.

It can be seen that if a 0 inclusive {Q}numeral is transformed into a {Q^{Δ}} numeral, when Q=2, it is still a {Q^{Δ}} numeral; when Q is an even number that is greater than 2, it is the sum of two {Q^{Δ}} numerals, and one of the {Q^{Δ}} numeral is the numeral indicated in the “carry line”. Hence, if K 0 inclusive {Q}numerals are transformed into the corresponding {Q^{Δ}} numerals, when Q=2, they are still K {Q^{Δ}} numerals; when Q is an even number that is greater than 2, they are the sum of 2K {Q^{Δ}} numerals.

(II) In the case of 0 exclusive numerals, Q is a positive odd numeral, and the same conclusion is proved to be existing.

(III) If a {Q} numeral has been transformed into a {Q^{Δ}} numerals, then K {Q} numerals can be transformed into K {Q^{Δ}} numerals.

Therefore, when K {Q} numerals is transformed into the corresponding K {Q^{Δ}} numerals, they can be considered as the sum of 2K {Q^{Δ}} numerals.

In the present invention, 2K enhanced Q-ary numerals are used for depiction. When Q=10, the enhanced Q-ary becomes enhanced decimal {ten^{Δ}}; wherein the method of carrying out computations of rational numbers by using the partial Q-ary and <<carry line method>> is named as <<method of hybrid Q-ary and carry line>>, or as <<partial carry method PJF>>. Suppose that K common Q-ary numerals participate in the computation of addition and subtraction, K is an integer not less than 2 and Q is a natural number. It can be proved by the same reasoning that there is a similar conclusion to that in the enhanced Q-ary. These numerals are transformed into K or 2K partial Q-ary numerals. In the present invention, 2K partial Q-ary numerals are used for depiction. When Q=10, the partial Q-ary becomes a partial decimal {ten*}.

3.1 Four Arithmetic Operations

3.1.1 Addition of {Ten*}

For example, in the formula 1 2̅3+4 5̅ 6̅=427, the sum obtained is 5 7̅ 3̅. When there is the need to transform it into common decimal {ten} numeral, the sum is 427. Generally speaking, the obtained sum of 5 7̅ 3̅ does not need to be transformed (especially when it is used as the intermediate result in the computation process). When there is the need for transformation, the method is as shown in the transformation rules in section 4.1.

3.1.2 Subtraction of {Ten*}

For example, 1 2̅3−4 5̅ 6̅=1 2̅3+ 4̅56= 3̅39 or 112+56−32−85+67−46=72

3.1.3 Multiplication of {Ten*}

For example, 2 3̅ 8̅×8 9̅=12 5̅02

3.1.4 Division of {Ten*}

For example, 5728÷23=249 . . . 1

3.1.5 Addition of {Ten^{Δ}}

For example, 1 2̅3+344=43 3̅, the sum obtained is 43 3̅. When there is the need to transform it into common decimal {ten} numeral, the sum is 427. Generally speaking, the obtained sum of 43 3̅ does not need to be transformed (especially when it is used as the intermediate result in the computation process). When there is the need for transformation, the method is as shown in the transformation rules in section 4.1.

3.1.6 Subtraction of {Ten^{Δ}}

For example, 1 2̅3−344=1 2̅3+ 3̅ 4̅ 4̅= 3̅4 1̅; or 112+1 4̅ 4̅−32−1 2̅5+1 3̅ 3̅−5 4̅=1 3̅2

3.1.7 Multiplication of {Ten^{Δ}}

For example, 2 4̅2×1 3̅1=11502

3.1.8 Division of {Ten^{Δ}}

For example, 1 4̅ 3̅3 2̅÷23=25 1̅ 1

3.1.9 Addition of {Ten^{Δ}}

For example, 1 2̅3+344=43 3̅, the sum obtained is 43 3̅. When there is the need to transform it into common decimal {ten} numeral, the sum is 427. Generally speaking, the obtained sum of 43 3̅ does not need to be transformed (especially when it is used as the intermediate result in the computation process). When there is the need for transformation, the method is as shown in the transformation rules in section 4.1.

3.1.10 Subtraction of {Ten′}

For example, 1 2̅3−344=1 2̅3+ 3̅ 4̅ 4̅= 3̅4 1̅; or for example 112+1 4̅ 4̅−32−1 2̅5+1 3̅ 3̅−5 4̅=1 3̅2

3.1.11 Multiplication of {Ten′}

For example, 2 4̅2×1 3̅1=11502

3.1.12 Division of {Ten′}

For example, 1 4̅ 3̅3 2̅÷23=25 1̅ 1

3.2 Characteristics of Four Arithmetic Operations

\textcircled{1} Addition and subtraction are combined into addition

First, subtraction is transformed into addition for computation, so in real computation, the addition and subtraction are combined into addition, which eliminated the difficulty of successive addition and subtraction, and this is determined by the characteristics of hybrid numerals. Specially attention shall be directed to the “reduction of hybrid numerals” in basic computation here. It means that when n numerals at the same place are added for the sum, if the sum is 0, these n numerals can be cancelled. The “reduction of hybrid numerals” can also be called “counterpart canceling” or “counterpart scratching”. That is, during “scratching Q” as mentioned previously, when m=0, it is called “counterpart scratching”. In the formula, said n numerals at said place can be scratched out by backlashes and will not participate in the subsequent computation. In real computation, the result of the hybrid numerals is obtained by repetitively performing “counterpart scratching”, “scratching Q”, and “accumulating”.

\textcircled{2} The methods for multiplication and division are simple

Thanks to the use of hybrid numerals, the “subtracting” process in the division can be changed into the “adding” process, moreover, the sign of the divident can be reversed, then the whole process “subtraction” is completely changed into a process of “addition”, and this may further reduce the complexity of the whole computation. From now on, we use this method to perform division. But it should be noted that if arithmetical compliment appears at this time, the sign thereof should be reversed to obtain the arithmetical compliment of the final result of computation.

Meanwhile, the process of trying the quotients in division can be changed into the predefined iterative process.

\textcircled{3} The speed for addition, subtraction, multiplication and division in the four arithmetic operations can by remarkably increased.

\textcircled{4} Guarantee for the correctness of the computation is enhanced, and in the “written calculation engineering”, the error rate of written calculation is greatly reduced.

4. The Relationship Between Hybrid Decimal {Ten*} and Common Decimal {Ten}

4.1 The Method for Transformation Between the Numerals of {Ten*} and {Ten}

Integers are referred to herein, for example, {ten*} 3 8̅2 2̅ 9̅6={ten} 221716. {ten} numeral per se is a special case of {ten*} numeral, so {ten} numeral is just {ten*} numeral without any transformation, and only the positive and negative signs of these common Q-ary numerals are to be assigned to each place of these corresponding numerals.

There are several methods for transforming {ten*} numerals into {ten} numerals. One is to change the {ten *} numeral into a positive {ten} numeral and a negative {ten} numeral and add them for the sum. There are many ways of doing this, wherein the typical one is to take the positive numeral places and the 0 place in said {ten*} numeral as a positive {ten} numeral, while take the negative numeral places as a negative {ten} numeral. For example, {ten*}3 8̅2 2̅ 9̅6={ten} 302006−80290=221716. Another is to make the positive numeral at each place of said numeral unchanged, and make the negative numeral to become the “complement” of its absolute value for 10, meanwhile, the adjacent higher place is subtracted by 1 (i.e., added by 1̅). A further method is that in each place of said numeral, the numeral segment of successive positive numerals (or 0) are written as it is, for example, 3x2xx6. However, when it is not at the end (the place of units) of the {ten*} numeral, the lowest place is added by 1̅; as for numeral segment of successive negative numerals, the negative numeral is changed into the “complement” of its absolute value for 9, e.g., x1x70x, then the lowest place thereof is added by 1. In this way, the result is obtained to be 221716, which is the corresponding {ten} numeral.

When the first place of said {ten*} numeral to be transformed is negative, that is, said numeral is a negative numeral, the reverse numeral of said numeral is transformed into {ten} numeral, then the sign of said {ten} numeral is taken to be negative.

4.2 Comparison Table of {Ten*} and {Ten} and the Explanations (See Table 1)

\textcircled{1} In the table 1, 0₊ and 0₋ are respectively 0 obtained by approaching 0 from the positive and negative directions.

\textcircled{2} In the table 1, \dot{9} is the abbreviation of the whole of “consecutive, non-negative, integral number of 9”, i.e., 9 could be zero 9, one 9, or it could be 99, or 999, . . . . The aggregation expressed in such a form is called “continuous aggregation”, which is obviously an infinite aggregation. Assume that E is an integer, then \dot{E} is the “continuous aggregation” of E, which is called as “continuous E” and read as “E dot”. A group of endless numerals represented by the “continuous aggregation” is called “continuous array” or “group numerals of continuous aggregation”.

\textcircled{3} It can be learnt from the two forms of expression of 10 that

$$\overline{0} = 0 = \dot{0} = \dot{\overline{0}} .$$

\textcircled{4} In the system of {ten*} numerals, there are only four forms of “continuous aggregation”, i.e.,

$$( \dot{0} , \dot{\overline{0}} , \dot{9} , \dot{\overline{9}} )$$

Since.

$$\dot{0} = \dot{\overline{0}} ,$$

there are only three forms of “continuous aggregation”, i.e.,

$$( \dot{0} , \dot{9} , \dot{\overline{9}} ) ,$$

which can also be written as (\dot{0}, ±\dot{9})

TABLE 1

| | |
|---|---|
| 0 = 00 = 000 = . . . = \dot{0} = 0₊ | 0̅ = 0̅ 0̅ = 0̅ 0̅ 0̅ = . . . = [symbol] = 0₋ |
| 1 = 1 9̅ = 1 9̅ 9̅ = . . . = [symbol] | 1̅ = 1̅9 = 1̅99 = . . . = 1̅\dot{9} |
| 2 = 1 8̅ = 1 9̅ 8̅ = . . . = [symbol] | 2̅ = 1̅8 = 1̅99 = . . . = 1̅\dot{9}8 |
| 3 = 1 7̅ = 1 9̅ 7̅ = . . . = [symbol] | 3̅ = 1̅7 = 1̅98 = . . . = 1̅\dot{9}7 |
| 4 = 1 6̅ = 1 9̅ 6̅ = . . . = [symbol] | 4̅ = 1̅6 = 1̅96 = . . . = 1̅\dot{9}6 |
| 5 = 1 5̅ = 1 9̅ 5̅ = . . . = [symbol] | 5̅ = 1̅5 = 1̅95 = . . . = 1̅\dot{9}5 |
| 6 = 1 4̅ = 1 9̅ 4̅ = . . . = [symbol] | 6̅ = 1̅4 = 1̅94 = . . . = 1̅\dot{9}4 |
| 7 = 1 3̅ = 1 9̅ 3̅ = . . . = [symbol] | 7̅ = 1̅3 = 1̅93 = . . . = 1̅\dot{9}3 |
| 8 = 1 2̅ = 1 9̅ 2̅ = . . . = [symbol] | 8̅ = 1̅2 = 1̅92 = . . . = 1̅\dot{9}2 |
| 9 = 1 1̅ = 1 9̅ 1̅ = . . . = [symbol] | 9̅ = 1̅1 = 1̅91 = . . . = 1̅\dot{9}1 |

| | | | | | |
|---|---|---|---|---|---|
| | | 1 0̅ = 1 9̅ 0̅ = . . . = [symbol] | | | 1̅0 = 1̅90 = . . . = 1̅\dot{9}0 |
| 10 = | {open oversize brace} | | 1̅ 0̅ = | {open oversize brace} | |
| | | 10 = 1 9̅0 = . . . = [symbol] | | | 1̅ 0̅ = 1̅9 0̅ = . . . = 1̅\dot{9} 0̅ |

| | |
|---|---|
| 11 = 11 = 1 9̅1 = . . . = [symbol] | 1̅ 1̅ = 1̅ 1̅ = 1̅9 1̅ = . . . = 1̅\dot{9} 1̅ |
| . | . |
| . | . |
| . | . |

4.3 Analysis of the Relationship Between {Ten*} and {Ten}

{ten} numeral is part of {ten*} numeral, and the {ten} numeral set is the proper subset of {ten *} numeral set; {ten*} numeral ⊃ {ten} numeral, that is, {ten*} numeral has proper inclusion relationship for {ten} numeral. The relationship between the {ten} numeral and the {ten*} numeral is “one to many correspondence” instead of “one to one correspondence”. Because of this, {ten*} has the flexibility of diversified processing, and this explains for the diversity and rapidity of {ten*} computation. From this point of view, {ten*} has more powerful functions.

In {ten}, P=Q, so in said numerical system, natural numerals are expressed in the unique and successive form, so there is no diversity and thus lacking the corresponding flexibility. In {ten* }, P>Q, so in said numerical system, the natural numerals sometimes manifest themselves in many forms, and this is the reason why said numerical system is flexible. It makes the computation simple and fast. It is also justifiable to say that {ten*} sacrifices diversity for flexibility. Only under the existence of {ten*}, can the <<hybrid carry method HJF>> and the new technical solution of “written calculation engineering” come into existence, and only under the existence of {ten*}, can the processor and the corresponding new technical solution of computer come into existence.

When {ten*} numeral is transformed into {ten} numeral, it can only be transformed into an unique corresponding numeral, this is because that {ten*} numeral can be directly obtained by adding and subtracting of {ten} numeral, while the result of the addition and subtraction computations of {ten} numeral is unique. Contrarily, {ten} numeral can only be transformed into the unique corresponding “group numerals of continuous aggregation” for a set of {ten*}. Therefore, the relationship between the “one” of {ten} numeral and the “one” group of the “group numerals of continuous aggregation” for {ten*} is “one to one correspondence”. Thereby, the relationship that the {ten*} numeral and the {ten} numeral are mapping to each other is established. Since the transformation is a correspondence of the set to itself, {ten} numeral and {ten*} numeral are “one to one transformation”. As for the computation system, {ten} and {ten*} numeral systems are “automorphism”. All the computational characters corresponding to the {ten} numeral are also valid in the {ten*} numeral system.

It shall be pointed out that of course the above analysis for the {ten} and {ten*} numerals is completely corresponding to the analysis for the {Q} and {Q*}, because {ten} and {Q} are isomorphic. Therefore, \textcircled{1} {Q} numeral is part of {Q*} numeral, and {Q} numeral set is a proper subset of {Q*} numeral set; {Q*} numeral ⊃ {Q} numeral, i.e., {Q*} numeral has proper inclusion relationship for the {Q} numeral. \textcircled{2} The relationship between the {Q} numeral and {Q*} numeral is “one to many correspondence” instead of “one to one correspondence”. \textcircled{3} Meanwhile, the relationship between “one” numeral in {Q} and “one” group of the “group numerals of continuous aggregation” in {Q*} is “one to one correspondence”. \textcircled{4} {Q} and {Q*} numeral systems are “automorphism”. All the computational characters corresponding to the {Q} numeral system are also valid in the {Q*} numeral system.

The following sections 4 to 4.3 describe the enhanced Q-ary

4. The Relationship Between the Enhanced Decimal {Ten^{Δ}} and the Common Decimal {Ten}

4.1 Method of Transformation Between {Ten^{Δ}} Numeral and {Ten} Numeral

Integers are referred to herein, for example, {ten^{Δ}}222 3̅2 4̅={ten} 221716. The {ten}numeral shall be transformed into {ten^{Δ}} numeral by means of table 1. There are several methods for transforming {ten^{Δ}} numeral into {ten} numeral. One is to change the {ten^{Δ}} numeral into a positive {ten} numeral and a negative {ten} numeral and add them for the sum. There are many ways of doing this, wherein the typical one is to take the positive numeral places and the 0 place in said {ten^{Δ}} numeral as a positive {ten} numeral, while take the negative numeral places as a negative {ten} numeral. For example, {ten^{Δ}}222324={ten} 222020−304=221716. Another is to make the positive numeral at each place of said numeral unchanged, and make the negative numeral to become the “complement” of its absolute value for 10, meanwhile, the adjacent higher place is subtracted by 1 (i.e., added by 1̅). A further method is that in each place of said numeral, the numeral segment of successive positive numerals (or 0) are written as it is, for example, 222x2x. However, when it is not at the end (the place of units) of the {ten^{Δ}}numeral, the lowest place is added by 1̅; as for numeral segment of successive negative numerals, the negative numeral is changed into the “complement” of its absolute value for 9, e.g., xxx6x5, then the lowest place thereof is added by 1. In this way, the result is obtained to be 221716, which is the corresponding {ten} numeral.

When the first place of said {ten^{Δ}} numeral to be transformed is negative, that is, said numeral is a negative numeral, the reverse numeral of said numeral is transformed into {ten} numeral, then the sign of said {ten} numeral is taken to be negative.

4.2 The Comparison Table of {Ten^{Δ}} and {Ten} and the Explanations (Table 1)

TABLE 1
the comparison table between numerals of {ten^{Δ}} and {ten}

| | | | | | | | | | | | | | | | | | | | | | |
|---|---|---|---|---|---|---|---|---|---|---|---|---|---|---|---|---|---|---|---|---|---|
| . . . 1̅0̅ | 9̅ | 8̅ | 7̅ | 6̅ | 5̅ | 4̅ | 3̅ | 2̅ | 1̅ | 0 | 1 | 2 | 3 | 4 | 5 | 6 | 7 | 8 | 9 | 10 . . . | {+} |
| . . . 1̅0 | 1̅1 | 1̅2 | 1̅3 | 1̅4 | 5̅ | 4̅ | 3̅ | 2̅ | 1̅ | 0 | 1 | 2 | 3 | 4 | 5 | 1 4̅ | 1 3̅ | 1 2̅ | 1 1̅ | 1 0̅ . . . | {+^{Δ}} |

| | |
|---|---|
| 1̅5 | 1 5̅ |

\textcircled{1} The {ten^{Δ}} numerals corresponding to {ten} numerals may or may not include repetitive numerals; wherein when numeral 5 (positive or negative) does not appear in {ten^{Δ}} numerals, there is no repetitive {ten^{Δ}} numeral in the corresponding {ten} numeral.

\textcircled{2} When numeral 5 (positive or negative) appears in {ten^{Δ}} numerals, there is repetitive {ten^{Δ}} numeral in the corresponding {ten} numeral. At this time, there may or may not be numeral 5 in the corresponding {ten} numeral. As for the repetitive numeral of {ten^{Δ}} numeral to {ten} numeral, 5=1 5̅ and 5̅= 1̅5 are the “main repetitions” and the rest of the repetitive numerals can be deduced therefrom.

3̅ In fact, the set of numerical elements of {ten^{Δ}} includes both 5̅ and 1̅5, so the corresponding repetitive numerals occur. In other words, if 5̅ or 1̅5 is removed from the set of numerical elements of {ten^{Δ}}, there will be no repetitive numeral. And such numerical system without repetitive numeral is called a partial Q-ary {Q′}, where Q=10.

4.3 Analysis of the Relationship Between {Ten^{Δ}} and {Ten}

The relationship between the {ten} numeral and the {ten^{Δ}} numeral is a partial “one to many correspondence” relationship instead of a “one to one correspondence” relationship, so the partial diversity of {ten^{Δ}} results in the flexibility in part of the processing, and this explains for the partial rapidity in the computation of {ten^{Δ}}. From this point of view, {ten^{Δ}} has more powerful functions. When {ten^{Δ}} numeral is transformed into {ten} numeral, it can only be transformed into an unique corresponding numeral, this is because that {ten^{Δ}} numeral can be directly obtained by adding and subtracting of {ten} numeral, while the result of the addition and subtraction computations of {ten} numeral is unique. Contrarily, {ten} numeral can only be transformed into the unique corresponding group of {ten^{Δ}} numerals. Therefore, the relationship between the “one” of {ten} numeral and the “one” group of {ten^{Δ}}numerals is “one to one correspondence”. Thereby, the relationship that the {ten^{Δ}}numeral and the {ten} numeral are mapping to each other is established. As for the computation system, {ten} and {ten^{Δ}} numeral systems are “automorphism”. All the computational characters corresponding to the {ten} numeral are also valid in the {ten^{Δ}} numeral system.

In {ten^{Δ}}, P>Q, so in said numerical system, the natural numerals sometimes manifest themselves in many forms, and this is the reason why said numerical system is flexible. It makes the computation simple and fast. It is also justifiable to say that {ten^{Δ}} sacrifices partial diversity for partial flexibility. In {ten}, P=Q, and the natural numbers are expressed in a successive and unique form, so it does not have such diversity and thus lacking the corresponding flexibility.

It shall be pointed out that of course the above analysis for the {ten} and {ten^{Δ}} numerals is completely corresponding to the analysis for the {Q} and {Q^{Δ}}, because {ten} and {Q} are isomorphic. Therefore, \textcircled{1} the relationship between the {Q} numeral and the {Q^{Δ}} numeral is partial “one to many correspondence” instead of “one to one correspondence”. \hat{2} The relationship between “one” numeral in {Q} and a group of numerals in {Q^{Δ}} numeral is “one to one correspondence”. \textcircled{3} {Q} and {Q^{Δ}} numeral systems are “automorphism”. All the computational characters corresponding to the {Q} numeral system are also valid in the {Q^{Δ}} numeral system.

The following sections 4 to 4.3 describe the partial Q-ary

4. The Relationship Between the Partial Decimal {Ten} and the Common Decimal {Ten}

4.1 Method of Transformation Between {Ten′} and {Ten} Numeral

Integers are referred to herein, for example, {ten′}222 3̅2 4̅={ten} 221716. The {ten} numeral shall be transformed into {ten′} numeral by means of table 1. There are several methods for transforming {ten′} numeral into {ten} numeral. One is to change the {ten′} numeral into a positive {ten} numeral and a negative {ten} numeral and add them for the sum. There are many ways of doing this, wherein the typical one is to take the positive numeral places and the 0 place in said {ten′} numeral as a positive {ten} numeral, while take the negative numeral places as a negative {ten} numeral. For example, {ten′}222 3̅2 4̅={ten} 222020−304=221716. Another is to make the positive numeral at each place of said numeral unchanged, and make the negative numeral to become the “complement” of its absolute value for 10, meanwhile, the adjacent higher place is subtracted by 1 (i.e., added by 1̅). A further method is that in each place of said numeral, the numeral segment of successive positive numerals (or 0) are written as it is, for example, 222x2x. However, when it is not at the end (the place of units) of the {ten′} numeral, the lowest place is added by 1̅; as for numeral segment of successive negative numerals, the negative numeral is changed into the “complement” of its absolute value for 9, e.g., xxx6x5, then the lowest place thereof is added by 1. In this way, the result is obtained to be 221716, which is the corresponding {ten} numeral.

When the first place of said {ten′} numeral to be transformed is negative, that is, said numeral is a negative numeral, the reverse numeral of said numeral is transformed into {ten} numeral, then the sign of said {ten} numeral is taken to be negative.

4.2 The Comparison Table of {Ten′} and {Ten} and the Explanations (Table 1)

Note: the numerical system of “common Q-ary” as shown in table 1 is a very important one in the partial Q-ary {Q′}, where Q=10.

4.3 Analysis of the Relationship Between {Ten′} and {Ten}

TABLE 1
the comparison table between numerals of {ten′} and {ten}

| | | | | | | | | | | | | | | | | | | | | | |
|---|---|---|---|---|---|---|---|---|---|---|---|---|---|---|---|---|---|---|---|---|---|
| . . . 1̅0̅ | 9̅ | 8̅ | 7̅ | 6̅ | 5̅ | 4̅ | 3̅ | 2̅ | 1̅ | 0 | 1 | 2 | 3 | 4 | 5 | 6 | 7 | 8 | 9 | 10 . . . | {+} |
| . . . 1̅0 | 1̅1 | 1̅2 | 1̅3 | 1̅4 | 1̅5 | 4̅ | 3̅ | 2̅ | 1̅ | 0 | 1 | 2 | 3 | 4 | 5 | 1 4̅ | 1 3̅ | 1 2̅ | 1 1̅ | 1 0̅ . . . | {+′} |

4.3.1 The relationship between the {ten′} numeral and the {ten} numeral is “one to one correspondence”. When {ten′} numeral is transformed into {ten} numeral, it can only be transformed into an unique corresponding numeral, this is because that {ten′} numeral can be directly obtained by adding and subtracting of {ten} numeral, while the result of the addition and subtraction computations of {ten} numeral is unique. Contrarily, {ten} numeral can only be transformed into an unique {ten′} numeral.

4.3.2 Therefore, the relationship of mapping between the {ten′} numeral and the {ten} numeral is established. As for the computation system, {ten} and {ten′} numeral systems are “automorphism”. All the basic computational characters corresponding to the {ten} numeral are also valid in the {ten′} numeral system.

4.3.3 In {ten′}, P=Q, so in said numerical system, natural numerals are expressed in the unique and successive form, so there is no diversity and thus lacking the corresponding flexibility.

4.3.4 It shall be pointed out that of course the above analysis for the {ten} and {ten′} numerals is completely corresponding to the analysis for the {Q} and {Q′}, because {ten} and {Q} are isomorphic. Therefore, \textcircled{1} the relationship between the {Q} numeral and the {Q′} numeral is “one to one correspondence”. \textcircled{2} {Q} and {Q′} numeral systems are “automorphism”. All the basic computational characters corresponding to the {Q} numeral system are also valid in the {Q′} numeral system.

The above sections 4 to 4.3 describe the situations of hybrid Q-ary, enhanced Q-ary and partial Q-ary.

5. Conclusion

In digital engineering, hybrid numeral carry system and <<hybrid carry method HJF>> could notably increase the computation speed, and greatly reduce the error rate of written calculation. It is just the application of the “engineering technique of direct application” of the third hierarchy of mathematics as indicated by QIAN, Xuesen to engineering. Once such “engineering technique” is closely associated with the digital computation engineering, it is called “digital engineering method of hybrid numeral carry system, carry line”, or <<hybrid carry method HJF>> for short.

Part II Technical Solution of Written Calculation Engineering of Hybrid Numeral Carry System and Carry Line

(I) In written calculation engineering, under the premise of correct principles, there are two important aspects for numerical value computation, one is avoiding errors as far as possible, and the other is making the speed of computation as fast as possible. However, in practice, these two aspects are in contradiction, because the speed of computation has to be lowered so as to avoid errors, and if the speed of computation is increased, errors usually occur.

The key factors that restrict said two aspects are “carry and borrow”. By means of the above-described written calculation engineering of “digital engineering method of hybrid numeral carry system and carry line”, the concepts on each computation layer can be made simpler, clearer and more fundamental during numerical value computation. Meanwhile, the corresponding computations can become more convenient. Thus errors in numerical value computation are notably reduced and the computation speed is remarkably increased.

Therefore, the technical solution of written calculation engineering adopts the <<hybrid carry method HJF>>, thus becoming the “technical solution of written calculation engineering of hybrid numeral carry system and carry line”. On the other hand, since the most commonly used numerals is the common decimal numerals, and the basic mathematics use the common decimal numerals, the new technical solution of written calculation engineering uses the hybrid decimal, enhanced decimal or partial decimal among the hybrid Q-ary, enhanced Q-ary or partial Q-ary for computation.

(II) In the technical solution of written calculation engineering of hybrid numeral carry system and carry line, the computation using the “digital engineering method of hybrid numeral carry system and carry line” can be as solution 1: \textcircled{1} the common Q-ary numeral is encoded or otherwise transformed into numerals of hybrid numeral carry system; \textcircled{2} computation of hybrid numeral carry system (“counterpart scratching”, “scratching Q”, “accumulating”); \textcircled{3} numeral of hybrid numeral carry system is decoded or otherwise transformed into common Q-ary numeral; or as solution 2 (which can be applied to written calculation engineering, or which may be left un-used): \textcircled{1} common Q-ary numeral is encoded or otherwise transformed into numeral of hybrid numeral carry system; and the numeral of hybrid numeral carry system is encoded into “numeral of encoded all one carry system”; \textcircled{2} computation of “numeral of encoded all one carry system” (“counterpart scratching”, “scratching Q”, “accumulating”); \textcircled{3} “numeral of encoded all one carry system” is decoded into numeral of hybrid numeral carry system; and the numeral of hybrid numeral carry system is decoded or otherwise transformed into common Q-ary numeral.

In the present invention, solution 1 is used for the technical solution of written calculation engineering of hybrid numeral carry system and carry line“.

(III) In the technical solution of written calculation engineering of hybrid numeral carry system and carry line”, the “digital engineering method of hybrid numeral carry system and carry line” includes one of the following two processes.

The technical solution of written calculation engineering of hybrid numeral carry system and carry line of the present invention uses the second process.

(III) In the technical solution of written calculation engineering of hybrid numeral carry system and carry line, “multiple computation” is adopted. That is, addition and subtraction of a plurality of numerals are finished in a single computation, thus completely overcoming the difficulty in “successive subtraction” and “successive addition and subtraction”. Meanwhile, multiplication is in substance “successive addition”, and division is in substance “successive subtraction”, so in multiplication and division, “multiple computation” can also be used.

(IV) In the technical solution of written calculation engineering of hybrid numeral carry system and carry line, “three-dimensional computation” can also be used. That is, in “multiple computation”, the numerals participating the computation are encoded by all one code, that is, each place of numeral S of the respective numerals of the hybrid numeral carry system is corresponded by 1 with the number of |S| arranged from the lowest place to the higher places sequentially, and the rest of the higher places are 0; meanwhile, the sign of S, i.e., the sign that indicates if the numeral of said place is positive or negative, is used as the sign of each place in the corresponding all one code. When all one code is used to encode numerals of hybrid numeral carry system, the addition of n numerals is only the non-repetitive arrangement of 1 or 1̅ of the n numerals, and the encoding and decoding of the all one code could use either fixed code length or variable code length.

(V) In the technical solution of written calculation engineering of hybrid numeral carry system and carry line, computations of “counterpart scratching” (reduction of hybrid numerals) and “scratching Q” are widely used for increasing the speed of computation and simplifying the picture of computation. When the computation for sum is performed for n numerals in K hybrid numerals, if, at a certain place, the sum by place of n computation numbers is zero, but a carry m (which has the same sign as the sum of the n numerals) is produced; n is an integer and n≧2, m is an integer, the carry is put into the next computation layer or at the empty place or zero place of the adjacent higher place of any data line that has not undergone the computation in the present computation layer; then a certain place of the n computation numbers are set to be “O” in a logical manner so that they will not participate in the subsequent computations, this is called “scratching Q”; in “scratching Q”, when m=0, it is called “counterpart scratching”.

It has been proved theoretically and practically that the written calculation engineering of digital engineering method of hybrid numeral carry system and carry line is an excellent technical solution of written calculation engineering. Basically, it comprehensively and systemically changes the four arithmetic operations of +, −, ×, ÷, i.e. the computation of rational numbers. It is convenient and easy, and even for a beginner, the computations of addition and subtraction can be extended to any number of numerals, and each numeral can be extended to have any number of places, without any special limitation. The low error rate and fast speed thereof smoothly realizes the mathematical computation and the principle of making the teaching of mathematics joyful.

### BRIEF SUMMARY

It is feasible to apply the digital engineering method of hybrid numeral carry system and carry line to written calculation engineering. The new technical solution of written calculation can greatly increase the speed of computation and reduce the error rate at the same time. The application of hybrid numeral carry system in the written calculation engineering is a revolution as compared to the application of common decimal {ten} to the written calculation engineering.

Such a new technical solution of written calculation engineering has great educational significance in brain written calculation, especially in textbooks. In consideration of the wide application and great significance of basic mathematics and the teaching thereof in the fields like human life, production and teaching at present and in the future, the use and value of the new technical solution of written calculation engineering is self-evident.

Part III Enhanced Q-Ary and All One Code

1. Enhanced Q-Ary

1.1 Definition and Symbols

In a Q-ary numerical system, all the carry systems of P>Q, especially P=Q+1>Q, are called “enhanced Q-ary”, where Q is a natural number. Wherein, the asymmetric enhanced Q-ary with 0 inclusive integer segment, is called “0 inclusive asymmetric enhanced Q-ary”. Obviously, {0, 1, 2} binary is “0 inclusive asymmetric enhanced binary; { 1̅, 0, 1 } binary is hybrid binary {two*}, i.e., it is “0 inclusive symmetric enhanced binary”. In addition, there are other enhanced binaries.

1.2 {0, 1 } One-Ary and the Computation Thereof

In the enhanced Q-ary, when Q=1, it is enhanced one-ary. The enhanced one-ary mainly includes two types, one is {0, 1} one-ary, which could represent all the non-negative integers, and the element device thereof is a two-state device; the other is { 1̅, 1} one-ary, which can represent all the integers, and the element device thereof is also two-state device. Where there is no special notations, the “enhanced one-ary” mentioned below refers to {0, 1} one-ary.
computation of {0, 1} one-ary. Addition is provided herein, for example, {ten}4+3+2=9={0, 1} one-ary 110101+1011+101=11001100010101011= . . .

1.3 The Relationship Between {0, 1} One-Ary and {Q}

1.3.1 Method of Transforming Between {0, 1} One-Ary Numeral and {Q}.

When transforming {0, 1} one-ary numeral into {Q} numeral, the numeral 1 of each place of the {0, 1} one-ary numeral is counted by {Q}, and the obtained counting sum of {Q} is the corresponding {Q} numeral. That is, the numerical value of {Q} numeral is equal to the number of 1 in the {0, 1} one-ary numeral. Obviously, this is a very simple principle. (Table 2).

TABLE 2

| {0, 1} one-ary | {two} | {ten} |
|---|---|---|
| 000 | 0 | 0 |
| 001 | 1 | 1 |
| 010 | 1 | 1 |
| 011 | 10 | 2 |
| 100 | 1 | 1 |
| 101 | 10 | 2 |
| 110 | 10 | 2 |
| 111 | 11 | 3 |
| . | . | . |
| . | . | . |
| . | . | . |

TABLE 3

| {ten} | {two} | {0,1} one-ary |
|---|---|---|
| 0 | 000 | 0 . . . 00000000 = \dot{0} = 0 |
| 1 | 001 | 0 . . . 00000001 = 1 = 1\dot{0} |
| 2 | 010 | 0 . . . 00000011 = 11 = 11\dot{0} = 1\dot{0}1 = 1\dot{0}1\dot{0} = . . . |
| 3 | 011 | 0 . . . 00000111 = 111 = 111\dot{0} = 11\dot{0}1 = 11\dot{0}1\dot{0} = . . . |
| 4 | 100 | 0 . . . 00001111 = 1111 = 1111\dot{0} = 111\dot{0}1 = 111\dot{0}1\dot{0} = . . . |
| 5 | 101 | 0 . . . 00011111 = 11111 = 11111\dot{0} = 1111\dot{0}1 = 1111\dot{0}1\dot{0} = . . . |
| 6 | 110 | 0 . . . 00111111 = 111111 = 111111\dot{0} = 11111\dot{0}1 = 11111\dot{0}1\dot{0} = . . . |
| 7 | 111 | 0 . . . 01111111 = 1111111 = 1111111\dot{0} = 111111\dot{0}1 = 111111\dot{0}1\dot{0} = . . . |
| . | . | . |
| . | . | . |
| . | . | . |

When transforming {Q} numeral into {0, 1} one-ary numeral, each place of the {Q} numeral is multiplied by the weight of each place, then the products are listed in non-repetitive manners with the same number of 1 on the positions of the {0, 1} one-ary numeral to be represented. That is, the number of 1 in the {0, 1} one-ary numeral is equal to the numerical value of the {Q} numeral. Obviously, this is also a very simple principle (Table 3).

1.3.2 Comparison Table of {0, 1} One-Ary Numeral and {Q} Numeral and the Explanations Thereof

\textcircled{1} {0, 1} one-ary numerals can represent all the {Q} numerals.

\textcircled{2} There are a plurality of repetitive numerals, for example, in a four-bit {0, 1} one-ary numeral, except that 0 and 4 are non-repetitive, the rest of the numerals all have repetitive numerals. Wherein, there are four 1, six 2, four 3. Thus, the numbers of repetitive numerals of 0 to 4 are one, four, six, four, one. This is consistent with the expansion coefficient C^{k}ₙ of binomial. (The number of bit n is a natural numeral, and k is 0˜n.) (see Table 4, the Yang Hui Triangle)

TABLE 4
Yang Hui Triangle
1
1 1
1 2 1
1 3 3 1
1 4 6 4 1
.
.
.

\textcircled{3} In the table, \dot{0} is the abbreviation of the entirety of the “consecutive non-negative integral number of 0”, i.e., \dot{0} can be zero 0, one 0, it can be the form of 00, or 000, . . . etc.. The set expressed in such a form is called “continuous set”. Obviously, “continuous set” is infinite set. Assume that E is an integer, \dot{E} is the “continuous set” of E, which is named as “continuous E” for short and is read as “E dot”. A group of infinite numerals represented in the form of a “continuous set” is called “continuous set array” or “group numerals of continuous set”.

1.3.3 Analysis of the Relationship Between {0, 1} One-Ary and {Q}

(1) Q ⊃1, Q is a natural number; 1 is the smallest natural number and is also the most basic natural number unit. Q properly includes 1, thus establishing a natural association between the corresponding {Q} and {0, 1} one-ary.

(2) The relationship between {Q} numeral and {0, 1} one-ary numeral is “one to many correspondence” instead of “one to one correspondence”. In {0, 1} one-ary, P=Q+1>Q, so in said numerical system, the natural numerals sometimes manifest themselves in many forms, and this is why said numerical system is flexible. We can also say that {0, 1} one-ary sacrifices diversity for flexibility. In {Q}, P=Q, so in such kind of numerals, natural number is expressed in a unique and consecutive form, so it does not have such diversity and lacks the corresponding flexibility.

(3) When {0, 1} one-ary numeral is transformed into {Q} numeral, it can be transformed into one unique corresponding numeral, this is because that the {0, 1} one-ary numeral can be directly obtained through addition and subtraction of {Q} numeral, while the result of {Q} numeral after addition and subtraction is unique. Accordingly, {Q} numeral can only be transformed into the corresponding unique group of {0, 1} one-ary “group numerals of continuous set”. Hence, the relationship between the “one” of {Q} numeral and the “one” group of the “group numerals of continuous set” in {0, 1} one-ary is “one to one correspondence”. Thereby, a relationship of mapping to each other between the {0, 1} one-ary numeral and the {Q} numeral is established. As for the computation system, {Q} and {0, 1} one-ary numeral systems are “isomorphic”. All the basic operational characters corresponding to the {Q} numeral are also valid in the {0, 1} one-ary numeral system.

1.4 Application of {0, 1} One-Ary

Since the {0, 1} one-ary forms numerals by mating 0 to the unit element 1, and the weight is 1, the “computation” thereof is usually realized by “delivery”. This is one of the reasons why the computation speed of {0, 1} one-ary numeral is fast. The “carry” in the computation of {0, 1} one-ary numeral is also realized by the “scratching Q” logic in which the sum of adding by place of the present places of two numerals is 0 and the carry is Q. The realization of such “delivery” and “scratching Q” logic requires only a very simple structure, but the speed is extraordinarily fast. This is another reason for the rapidity of computation of {0, 1} one-ary numeral. When the {0, 1} one-ary numeral and the numerals of various hybrid numeral carry systems computed in combination, a logic of “counterpart scratching” with simpler structure and faster speed is supplemented, and this is the third reason for the rapidity of computation of {0, 1} one-ary numeral.

The combination of {0, 1} one-ary and various hybrid numeral carry systems enhanced the function. In view of the inherent associations among {0, 1} one-ary→{Q}→various hybrid numeral carry systems, all these are obviously within expectation.

2. All One-Ary, and All One Encoding

2.1 All One-Ary and All One Numeral

The diversity of the {0, 1} one-ary numeral enables the flexibility in multiple processing. However, since there is only one form, i.e., \dot{0}, of “continuous set” for {0, 1} one-ary numeral, and it is extremely diversified, it is possible that the form of “continuous set” appears in the same numeral for more than once; thus the form of the same numeral is too diversified to be handled and controlled, accordingly, equipment has to be added and the computation speed will be affected. Therefore, generally, it is necessary to add some restrictive conditions to the {0, 1} one-ary numeral, and the “all one-ary” is produced as a result.

In the positive integers of the {0, 1} one-ary, each group of “group numerals of continuous set” is limited to be expressed in the unique form of successively arranging the unit element 1 from right to left starting from the units place, and the higher places are all 0 or empty. For example, {ten} numeral 3={0, 1} one-ary numeral 111/111\dot{0}/11\dot{0}1 . . . (/means “or”), and it is defined as {ten} 3={0, 1} one-ary 111. Thus the repetitive numerals in each group of “group numerals of continuous set” are deleted and only the exclusive form of all being 1 is left, which we called “all one numeral”. The carry system expressing the all one numeral is called “all one-ary”. In table 3, the left forms of {0, 1} one-ary numeral are “all one-ary” numerals. Therefore, “all one-ary” can be {0, 1} one-ary with specific restrictive conditions.

TABLE 5

| One bit of all one code | {two} |
|---|---|
| 0 | 0 |
| 1 | 1 |

TABLE 6

| nine bits of all one code | {ten} |
|---|---|
| 00 . . . 0 | 0 |
| 00 . . . 0 | 1 |
| 00 . . . 11 | 2 |
| . | . |
| . | . |
| . | . |
| 111111111 | 9 |

In the “place value numerical system” of the <<theory of numerical system>>, the empty place in the numeral is defined to indicate the connotative “empty place 0”. In its numerical element collection, “empty place” is a special numerical element, which is called “empty place element” and “empty element” for short. Therefore, the all one-ary can be obtained from the {1} one-ary in the 0 exclusive, common Q-ary {0 exclusive, Q}, so the “all one-ary” can be defined as {1} one-ary, which is represented by symbol {one}. When the positive and negative integers are considered, the positive and negative signs of said all one-ary numeral can be assigned to each place of said numeral so as to form the all one-ary numeral with each place thereof having the same sign. In the present invention, such “all one-ary” is referred to unless special notes are given, and the symbol thereof is {one}.

The “all one-ary” can also be obtained from the “{ 1̅, 1} one-ary” in the 0 exclusive hybrid Q-ary {0 exclusive, Q*} with restrictive condition added. The restrictive condition is that the signs of each place of said numeral must be the same. The “all one-ary” can also be obtained from “{ 1̅, 1} one-ary” in the 0 exclusive enhanced one-ary added with the same restrictive condition as mentioned above. In addition, it can also be obtained from other hybrid numeral carry systems.

2.2 All One Code

All one-ary obviously has the following advantages and disadvantages. Advantages are: \textcircled{1} fast computation speed, “overturn” is replaced by “delivery”; \textcircled{2} during multiple computation, it is no longer necessary to get the sum two by two, and the result can be obtained by “counterpart scratching” first and then “scratching Q”, thus the general computation speed is greatly improved; \textcircled{3} the transformation between it and {Q} is convenient. Disadvantages are: \textcircled{1} too long “word length” and too many bits (when variable word length is used, the average word length is only half of it); \textcircled{2} small amount of loaded information. Therefore, by exploiting the advantages and avoiding the disadvantages of the all one-ary, it is suitable to encode numerals of various hybrid numeral carry systems by numerals of the all one-ary. Encoding by numerals of “all one-ary” is called “all one encoding”. The “all one numeral” adopted in “all one encoding” is called “all one code”. Table 5 shows the situation of encoding {two} numerical element by one bit of the all one code. It can be seen from table 5 that the {two} numeral encoded by one bit of the all one code is the {two} numeral per se. Table 6 shows the situation of encoding {ten} numerical element by nine bits of the all one code. It can be seen from table 6 that in the {ten} encoded by nine bits of the all one code, the code length increases 9 times (when the variable code length is used, the average code length increases only 5 times). For example, {ten} 23=all one code=≡. Numerals of various hybrid numeral carry systems can be encoded by all one code.

2.3 Computation of All One Code

The computation of all one code is very simple. The addition of n numerals is only the non-repetitive arrangement of 1 or 1̅ in the n numerals, which is called “arrangement of 1”. Take the addition of two numerals as an example, 11+111=11111. In particular, in the digital engineering of various hybrid numeral carry systems, the computation result of numerals of various hybrid numeral carry system can be obtained merely by “counterpart scratching” first and then “scratching Q”. When the final result needs to be output, the numerals of various hybrid numeral carry systems that are encoded by all one code are transformed into {Q} or {ten} numerals to be output.

2.4 Application of All One Code

The all one code is mainly applied to encoding {Q} numerals and numerals of various hybrid numeral carry systems, in particular,

\textcircled{1} by using the 9 bits of the all one code to encode {ten} numeral, the common decimal {ten}, all one code, carry line processor and written calculation engineering and abacus can be realized;

\textcircled{2} by using the 9 bits of the all one code to encode {ten*} numeral, the mixed decimal {ten*}, all one code, carry line processor and written calculation engineering and abacus can be realized;

\textcircled{3} by using the all one code to encode numerals of various hybrid numeral carry systems, the various hybrid numeral carry systems, all one code, carry line processor and written calculation engineering and abacus can be realized;

\textcircled{4} by using the all one code to encode {ten} or {ten*} numeral or numerals of various hybrid numeral carry systems, and using the “positive and negative code” to perform a second encoding, a new technical solution of abacus can be realized.

1. A digital engineering method of hybrid numeral carry system and carry line, which uses Q-ary numerals and computes with the Q-ary, Q being a natural number, characterized in that the digital engineering adopts the “numeral of hybrid numeral carry system” and computes by the “digital engineering method of hybrid numeral carry system and carry line”.

2. The digital engineering method of hybrid numeral carry system and carry line according to claim 1, characterized by that the computations of the “digital engineering method of hybrid numeral carry system and carry line” can be one of the following solutions: solution 1 (suitable for computer and written calculation engineering): \textcircled{1} the common Q-ary numeral is encoded or otherwise transformed into numeral of hybrid carry system; \textcircled{2} hybrid numeral carry system computation (“counterpart scratching”, “scratching Q”, “accumulating”); \textcircled{3} numeral of hybrid numeral carry system is decoded or otherwise transformed into common Q-ary numeral; solution 2 (suitable for computer, abacus, or for written calculation engineering, or it may be left un-used): \textcircled{1} common Q-ary numeral is encoded or otherwise transformed into numeral of hybrid numeral carry system; and the numeral of hybrid numeral carry system is encoded into “all one code”; \textcircled{2} “all one code” computation (“counterpart scratching”, “scratching Q”, “accumulating”); \textcircled{3} “all one code” is decoded into numeral of hybrid numeral carry system; and the numeral of hybrid numeral carry system is decoded or otherwise transformed into common Q-ary numeral; solution 3 (suitable for computer): \textcircled{1} the common Q-ary numeral is encoded or otherwise transformed into numeral of hybrid numeral carry system; and the numeral of hybrid numeral carry system is encoded or otherwise transformed into {0, ±1} binary numeral (a special case thereof is “common binary numeral”); \textcircled{2} {0, ±1} binary computation (“counterpart scratching”, “scratching Q”, “accumulating”); \textcircled{3} the {0, ±1} binary numeral is decoded or otherwise transformed into numeral of hybrid numeral carry system; and the numeral of hybrid numeral carry system is decoded or transformed into common Q-ary numeral; solution 4 (suitable for computer): \textcircled{1} the common Q-ary numeral is encoded or otherwise transformed into numeral of hybrid numeral carry system; and the numeral of hybrid numeral carry system is encoded or transformed into “encoded {0, ±1} binary numeral” (a special case thereof is “encoded common binary numeral”); \textcircled{2} “encoded {0, ±1} binary numeral” computation (“counterpart scratching”, “scratching Q”, “accumulating”); \textcircled{3} the “encoded {0, ±1} binary numeral” is decoded or otherwise transformed into numeral of hybrid numeral carry system; and the numeral of hybrid numeral carry system is decoded or otherwise transformed into common Q-ary numeral. In the present invention, solutions 1 and 2 are adopted.

3. The digital engineering method of hybrid numeral carry system and carry line according to claim 1, characterized by that the “digital engineering method of hybrid numeral carry system and carry line” includes one of the following three processes: in the first process,
step 1: suppose that K common Q-ary numerals participate in the computations of addition and subtraction, K is an integer and K≧2, and Q is a natural numeral; and these numerals are transformed into K or 2K numerals of hybrid carry system;
step 2: two of the K or 2K numerals are added for sum by using the hybrid numeral carry system; the computation starts from the lowest place, that is, at a certain place, said two numerals are added by place; then the sum of “adding by place” of said two numerals at said place is obtained by “counterpart scratching”, “scratching Q”, and “accumulating”; said sum is taken into the next computation layer as the “partial sum” numeral; meanwhile, the obtained “hybrid numeral carry” is stored in the next computation layer or at the empty place or zero place of the adjacent higher place of any data line that has not undergone the computation in the present computation layer;
step 3: at the higher place adjacent to said certain place, the computation of step 2 is repeated; this processing is repeated until the highest places of said two numerals have been computed; when parallel computation is adopted, computations in steps 2 and 3 are performed on each place of the two numerals at the same time, then the present step can be skipped; when serial and parallel computation is adopted, the processing is similar;
step 4: another two numerals of the K or 2K numerals are taken to perform the computations in steps 2 and 3; this processing is repeated until all the numerals in the K or 2K numerals or in the computation layer have been taken; when there is only one numeral left, it is directly moved to the next computation layer as the “partial sum” numeral;
step 5: in the next computation layer, the computations for the sum as described in the previous steps 2, 3 and 4 are performed on said “sum by place” numeral and the “carry” numeral; this processing is repeated until only one numeral is obtained after the computation in the computation layer; then the number of the sum finally obtained by addition computation with hybrid numeral carry system is just the result of addition and subtraction computations on the K common Q-ary numerals;
or in the second process:
step 1: suppose that K common Q-ary numerals participate in the computation of addition and subtraction, K is an integer and K≧2, and Q is a natural numeral; and these numerals are transformed into K or 2K numerals of hybrid carry system;
step 2: starting from the lowest place, that is, two to K or 2K numerals are taken to be added at the same time at a certain place; “counterpart scratching”, “scratching Q” and “accumulating” are adopted; that is, when two numerals are taken, the sum of “adding by place” of said two numerals at said place is obtained and is taken into the next computation layer as the “partial sum” numeral; meanwhile, the obtained “hybrid numeral carry” is stored in the next computation layer or at the empty place or zero place of the adjacent higher place of any data line that has not undergone the computation in the present computation layer;
step 3: another two numerals are taken from the K or 2K numerals to perform the computation of step 2; this processing is repeated until the K or 2K numerals or all the numerals in computation layer have been taken; when there is only one numeral left, it is directly moved to the next computation layer as the “partial sum” numeral;
when each of the numerals at the same place are computed at the same time, the computations of steps 2 and 3 are performed at the same time, then the present step can be skipped; at this time, “counterpart scratching” is first performed on the n numerals whose sum is 0 at the same place; then “scratching Q” is performed on n numerals whose sum is mQ; n is an integer and n≧2, m is an integer; the obtained “hybrid numeral carry” is stored in the next computation layer or at the empty place or zero place of the adjacent higher place of any data line that has not undergone the computation in the present computation layer; at the same place, the rest numerals are “accumulated” or are directly moved to the next computation layer; the accumulation is “multiple (not less than 2) numerals accumulation”, when the common “accumulation” of two numerals is adopted, sequential serial accumulation is performed;
step 4: at the higher place adjacent to said certain place, the computations in steps 2 and 3 are repeated, and this processing is repeated until computation has been performed on the highest place of the K or 2K numerals;
step 5: in the next computation layer, the computation for sum as described in the above steps 2, 3 and 4 is performed on said “sum by place” numeral and the “carry” numeral; this processing is repeated until only one numeral is obtained by the computation in the computation layer; then the number of the sum finally obtained by addition computation with hybrid numeral carry system is just the result of addition and subtraction computations on the K common Q-ary numerals; or in the third process:
step 1: suppose that K common Q-ary numerals participate in the computation of addition and subtraction, K is an integer and K≧2, and Q is a natural numeral; and these numerals are transformed into K or 2K numerals of hybrid carry system;
step 2: the so-called “two-dimensional computation” is adopted, i.e., computation is performed at each place of the K or 2K numerals at the same time, meanwhile, “counterpart scratching” is performed on the n numerals whose sum is 0 at each place; n is an integer and n≧2;
step 3: the so-called “two-dimensional computation” is adopted, i.e., computation is performed at each place of the K or 2K numerals at the same time, meanwhile, “scratching Q” is performed on n numerals whose sum is mQ at each place; n is an integer and n≧2, m is an integer; the obtained “hybrid numeral carry” is stored at the empty place or zero place of the adjacent higher place of any data line in the next computation layer;
step 4: the so-called “two-dimensional computation” is adopted, i.e., computation is performed at each place of the K or 2K numerals at the same time, meanwhile, the rest of the numerals at each place are “accumulated”; or they are directly moved to the next computation layer; the accumulation is “multiple (not less than 2) numerals accumulation”; when common “accumulation” of two numerals is adopted, sequential serial accumulation is performed;
step 5: in the next computation layer, the computations for sum as described in the above steps 2, 3 and 4 are performed on said “sum by place” numeral and the “carry” numeral; this processing is repeated until only one numeral is obtained by the computation in the computation layer; then the number of the sum finally obtained by addition computation with hybrid numeral carry system is just the result of addition and subtraction computations on the K common Q-ary numerals.

4. The digital engineering method of hybrid numeral carry system and carry line according to claim 1, characterized by that in the “digital engineering method of hybrid numeral carry system and carry line”, when the computation for sum is performed for n numerals from K numerals, if, at a certain place, the sum of adding by place of n computation numbers is zero, but a carry m (which has the same sign as the sum of the n numerals) is produced; n is an integer and n≧2, m is an integer, the carry is put into the next computation layer or at the empty place or zero place of the adjacent higher place of any data line that has not undergone the computation in the present computation layer; then a certain place of the n computation numbers are set to be “O” in a logical manner so that they will not participate in the subsequent computations, this is called “scratching Q”; in “scratching Q”, when m=0, it is called “counterpart scratching”; or “counterpart scratching” and “scratching Q” may not be adopted.

5. The digital engineering method of hybrid numeral carry system and carry line according to claim 1, characterized by that in the “digital engineering method of hybrid numeral carry system and carry line”, the numeral may not be encoded, or it may be encoded by the numeral of hybrid numeral carry system, or it may be also encoded by all one code, that is, each place of numeral S of the respective numerals of the hybrid numeral carry system is corresponded by 1 with number of |S| arranged from the lowest place to the higher places sequentially, and the rest of the higher places are 0; meanwhile, the sign of S, i.e., the sign that indicates if the numeral of said place is positive or negative, is used as the sign of each place in the corresponding all one code; when all one code is used to encode numerals of hybrid numeral carry system, the addition of n numerals is only the non-repetitive arrangement of 1 or 1̅ of the n numerals; and the encoding and decoding of the all one code could use either fixed code length or variable code length.

6. A technical solution of written calculation engineering for implementing the method of claim 1, which uses Q-ary numerals and computes with Q-ary, Q being a natural number, characterized in that the written calculation engineering uses numerals of “hybrid numeral carry system” and computes with the “digital engineering method of hybrid numeral carry system and carry line”.

7. The technical solution of written calculation engineering according to claim 6, wherein the computation using “digital engineering method of hybrid numeral carry system and carry line” in written calculation engineering can be the previously mentioned solution 1 or solution 2, and solution 1 is used here for depiction.

8. The technical solution of written calculation engineering according to claim 6, wherein the computation using “digital engineering method of hybrid numeral carry system and carry line” in written calculation engineering can be the previously mentioned first process or second process, and the second process is used here for depiction.

9. The technical solution of written calculation engineering according to claims 6, characterized by that in the written calculation using “digital engineering method of hybrid numeral carry system and carry line”, when the computation for sum is performed for n numerals from K numerals, if, at a certain place, the sum of adding by place of n computation numbers is zero, but a carry m (which has the same sign as the sum of the n numerals) is produced; n is an integer and n≧2, m is an integer, the carry is put into the next computation layer or at the empty place or zero place of the adjacent higher place of any data line that has not undergone the computation in the present computation layer; then a certain place of the n computation numbers are set to be “0” in a logical manner so that they will not participate in the subsequent computations, this is called “scratching Q”; in “scratching Q”, when m=0, it is called “counterpart scratching”; or “counterpart scratching” and “scratching Q” may not be adopted.

10. The technical solution of written calculation engineering according to claim 6, characterized by that in the written calculation using “digital engineering method of hybrid numeral carry system and carry line”, the computation numerals may not be encoded, or they may be encoded by the numeral of hybrid numeral carry system, or they may be encoded by all one code, that is, each place of numeral S of the respective numerals of the hybrid numeral carry system is corresponded by 1 with the number of |S| arranged from the lowest place to the higher places sequentially, and the rest of the higher places are 0; meanwhile, the sign of S, i.e., the sign that indicates if the numeral of said place is positive or negative, is used as the sign of each place in the corresponding all one code; when all one code is used to encode numerals of hybrid numeral carry system, the addition of n numerals is only the non-repetitive arrangement of 1 or 1̅ of the n numerals; and the encoding and decoding of the all one code could use either fixed code length or variable code length; in the written calculation engineering of hybrid numeral carry system and carry line according to the present invention, the variable code length is used.
